(19) United States
(12) Patent Application Publication
(10) Pub. No.: US 2011/0125551 A1
(43) Pub. Date: May 26, 2011

(54) Method and System for In-Store Media Measurement

(76) Inventor: Mark Peiser, New Canaan, CT (US)

(21) Appl. No.: 12/940,428

(22) Filed: Nov. 5, 2010

Related U.S. Application Data
(60) Provisional application No. 61/264,073, filed on Nov. 24, 2009.

(51) Int. Cl. G06Q 30/00; G06Q 10/00

(52) U.S. Cl. 705/7.31

(57) ABSTRACT

A system and method for determining the value of an in-store marketing program is disclosed. The invention combines household panel data and aisle traffic data to provide a statistically significant value determination of a in-store marketing program. In some embodiments the aisle traffic data is collected using GPS units or RFID tags. In some embodiments, the invention accounts for the value based on a specific demographic or specific target product usage. In further embodiments, the invention is configured to generate the value using a computer and software executing on the computer.

### CROSS-REFERENCE TO RELATED APPLICATIONS

The present application claims the benefit of priority under 35 U.S.C. §119(e) to U.S. Provisional Application No. 61/264,073 filed on Nov. 24, 2009, entitled “Method And System For In-Store Media Measurement,” the entirety of which is incorporated by reference herein.

### FIELD OF THE INVENTION

The present invention relates generally to a system and a method for measuring the value of media. More specifically the present invention relates to a more accurate system and method for measuring the media value of in-store marketing, advertising, and promotional programs.

### BACKGROUND OF THE INVENTION

In-store advertising and promotional programs provide an opportunity to advertise a brand or product to a consumer at the point of sale. In-store media may include, but is not limited to, shelf signs, cart signs, freezer decals, and coupon machines. In-store media is an important marketing tool because it directly connects the brand and consumer at the point of purchase. In-store media programs may include for example, but are not limited to, audio devices, print banners, decals used on freezer doors, coupon dispensing devices, video monitors, and any other form of advertisement, display, or other medium that is used to communicate to a customer regarding one or more products.

The value or cost of in-store media is measured in cost per impressions (“CPI”), or, more typically, cost per thousand impressions (“CPMI”). Impressions are calculated by multiplying the Reach (the number or percentage of a target population who have an opportunity to see an advertisement or promotion program), by the Frequency (the number of times each member of the target population is potentially exposed to the advertisement or promotion program).

An accurate CPMI is very important because it allows the advertiser to compare the effectiveness, i.e. number of impressions, of a particular advertising campaign, with the cost of that campaign.

A disadvantage of known systems and methods for calculating the CPMI for in-store media measurement is that they do not accurately reflect the location of the advertisement in the store, the number of times a shopper visits the store, and the demographics of the shopper. These disadvantages increase the margin of error in the CPMI derived from known systems and methods. As a result, advertisers may be reluctant to allocate a portion of their advertising budget to in-store media because they cannot accurately determine its value.

Media such as TV, radio, magazines, and newspapers have long established systems and methods for accurately measuring the value of media. For example, television rating systems track viewing habits of a defined population and then extrapolate those results across a larger population to generate ratings for a particular program or channel over the larger population. Such systems and methods provide a reliable means to determine the number of viewers for a particular program, and therefore its commercial advertising value. In addition, demographic data can further be incorporated into such systems to determine the number of viewers for a particular program in a particular demographic. Demographic data increases the usefulness of the ratings information by identifying more profitable audiences for specific commercial content. These known systems generate a useful CPMI for television because it results in a number having a small margin of error.

Unlike the television industry, known methods for generating a CPMI for in-store media and promotional programs have limited value because they have a large margin of error and do not accurately reflect the true CPMI. As a result, it is difficult to accurately determine the commercial value of in-store media.

Some systems and methods currently available for determining the CPMI of a particular in-store advertisement are based on survey data. In such systems and methods a group of consumers are surveyed regarding their shopping behavior during a specific time interval. For example, a survey may seek data related to the number of store visits during a specific month. Or a survey may seek data related to items purchased during a particular month, etc. A CPMI can be determined based in part on this survey data by extrapolating the results over a large population.

Another disadvantage of known survey based systems and methods for generating a CPMI for in-store media is that the known systems and methods are based on consumer recollection of past behavior. Recalled behavior is inaccurate and subject to significant error. Moreover, the risk of inaccuracy and failed consumer recollection increases with the time interval of the survey.

Another disadvantage of known survey based systems and methods for generating a CPMI for in-store media is that consumer recollection is inherently unreliable because survey respondents may unintentionally exaggerate responses or provide responses that do not accurately reflect relevant behavior during the specified time interval.

Another disadvantage of known survey based systems and methods for generating a CPMI for in-store media is that they do not account for variable aisle traffic patterns of the survey respondents. A typical store will have a number of different aisles on which different goods are arranged for purchase. Although survey data provides information related to store visits for the population comprising the survey respondents, i.e. total store impressions, it does not provide any data related to traffic patterns in the stores, e.g., percentage of overall store shoppers that visit the deli counter during their visit. Thus, a CPMI based on survey data alone is inherently error prone and inaccurate.

Another known system and method for measuring the value of in-store media combines the results of survey data and adjusts it for aisle traffic patterns. In these known systems and method, aisle traffic patterns are determined using subjective, error prone, methods and systems. For example, to calculate the traffic patterns, a person in a store visually monitors the number of shoppers that travel down a certain aisle. This information is then compared to the total number of shoppers entering the store to determine an aisle traffic pattern. Using this technique, the value of an in-store marketing program can be determined.

A disadvantage of this known system and method is that it relies on survey data, which as discussed above, is subject to large margins of error.

Another disadvantage of this known system and method is that it relies on humans to determine the traffic patterns of shoppers in the store. This method is subjective and prone to a large margin of error due to the inherent limitations of visual tracking.

Another known system and method for in-store media measurement is store aisle traffic measurement. In such known systems and methods store aisle traffic is tracked, for example, using methods for tracking the actual in-store patterns of customers. Such systems and methods may include, but are not limited to using global positioning system (“GPS”) units, radio frequency identification devices (“RFID”), motion detection cameras, thermal imaging devices, optical devices, mechanical devices, combinations thereof, or any other device or method for tracking in-store shopping patterns. For example, a tracking device is attached to the shopping cart or shopping basket. The device tracks the shopper's path as he walks through the store. In some known systems the device communicates with a central device in the store. Using this type of data, it is possible to objectively determine the percentage of shoppers who visit a specific location of a store during a particular visit. In addition, aisle traffic patterns in a store can be determined over a specific period of time. This data can then be extrapolated over a group of stores to provide an estimate of aisle traffic in a larger population with a very small margin of error. For example, 40% of all store shoppers visit the deli section during each trip to the supermarket. It is further possible to extrapolate such data to stores employing different aisle configurations using known methods.

A disadvantage of known tracking based systems and methods for measuring the value of in-store media is that they do not account for demographic data of stores or store customers. For example the percentage of a particular demographic who visit a particular aisle.

Another known system and method for determining the value of in-store media is household purchase panel measurement. In this system and method, shopping and purchasing patterns of a panel of shoppers is scientifically tracked over a period of time. In other words, this data is objectively based on consumer behavior as opposed to survey data which is subjective. Unlike the survey data, household purchase panel measurement relies on hard measurements to track store visits and purchases. For example, in some systems a handheld computer device is used to record items that are purchased by consumers and the date and time of such purchases. In other systems and methods the receipts of the panel members are tracked to provide an accurate accounting of store visits and goods purchased. In some known systems, the demographic data of each household is recorded at the beginning of each household's participation in the program. Using such known systems and methods it is possible to minimize the inaccuracy of consumer surveys.

Another disadvantage of known household purchase panel measurement systems and methods for generating a CPMI for in-store media is that such systems and methods may inflate total impressions for an advertisement located in a low traffic area of the store, as compared to an advertisement located in a high traffic area of the store.

There is a desire, therefore, for a more accurate system and method for measuring the value of in-store media that overcomes the disadvantages of the known systems and methods. There is a further desire for a system and method for determining a CPMI having a small margin for error.

### SUMMARY OF THE INVENTION

It is a further object of the present invention to provide a system and method for a more accurately estimating the value of in-store media.

It is a further object of the present invention to provide an improved system and method for determining the value of an in-store marketing program.

It is a further object of the present invention to provide a system and method for determining the value of an in-store marketing program that more accurately reflects the actual number of customer impressions.

It is a further object of the present invention to provide a system and method for determining the value of an in-store marketing program that is based on objective behavioral consumer data, as opposed to survey data.

It is a further object of the present invention to provide a system and method for determining the value of an in-store marketing program that is based on household purchase panel measurement.

It is a further object of the present invention to provide a system and method for determining the value of an in-store marketing program that is based on individual purchase panel measurement.

It is a further object of the present invention to provide a system and method for determining the value of an in-store marketing program wherein the determined value of the media is based on actual aisle traffic patterns in a store. In is a further objet of the present invention to provide a system and method for determining the value of an in-store marketing program wherein the determined value of the media is based on aisle traffic patterns of customers in a store, wherein the data is objectively collected and based on the actual behavior of a sample of customers, as opposed data collected from in-store observers.

It is a further object of the present invention to provide a system and method for determining the value of an in-store marketing program wherein the determined value of the media is based on a combination of objectively collected consumer data and aisle traffic data that is based on data collected from an automated tracking system, such as GPS units, radio frequency identification devices RFID, motion detection cameras, thermal imaging devices, optical devices, mechanical devices, combinations thereof, or any other device or method for tracking in-store shopping patterns.

It is a further object of the present invention to provide a system and method for determining the value of an in-store marketing program wherein the determined value of the media is adjusted for a specific demographic.

It is a further object of the present invention to provide a system and method for determining the value of an in-store marketing program wherein the determined value of the media is adjusted for customers that purchase a specific product.

It is a further object of the present invention to provide a system and method for determining the value of an in-store marketing program wherein the determined value of the media is adjusted for customers that purchase a specific product and adjusted for a specific demographic.

These and other objects of the present invention are achieved through one embodiment of the present invention that is a system for determining the value of an in-store marketing program. The inventive system includes a computer, an aisle traffic database containing a plurality of location identifiers, each said location identifier having an associated traffic rate. The system further includes a household panel database containing a plurality of target program identifiers, each said target program identifier having an associated visit rate. The system further includes software executing on said computer for querying said aisle traffic database by said location identifier to retrieve a traffic rate. The system further includes software executing on said computer for querying said household panel database by said target program identifier to retrieve a visit rate. The system further includes software executing on said computer for generating a media value for a marketing program based on said retrieved traffic rate and said retrieved visit rate, wherein the visit rates are generated using data objectively collected from a panel of shoppers.

In further embodiments of the present invention, the determined media value is expressed as a cost per a number of impressions. For example, the media value is expressed as a cost per thousand impressions.

In yet further embodiments of the present invention the media value is based on a number of stores in which the marketing program is placed. In yet further embodiments of the present invention the media value is based on the cost of the marketing program. In yet further embodiments of the present invention the media value is based on a number of cycles of the marketing program. For example, a program that runs for two months may be based on two cycles.

In yet further embodiments of the present invention the system comprises an interface and software executing on the computer for receiving a location identifier and a target program identifier entered at the interface.

In yet further embodiments of the present invention, the retrieved visit rate is adjusted based on a target demographic. In yet further embodiments of the present invention, the adjustment is based on a percentage of shoppers in the shopping panel who belong to the target demographic. In yet further embodiments of the present invention, the retrieved visit rate is adjusted based on a target product usage. In yet further embodiments of the present invention the adjustment is based on the percentage of shoppers in the shopping panel who purchase the target product.

In yet further embodiments of the present invention, the visit rate is generated using data objectively collected from a panel of households by tracking the purchases made by one or more members of each of the households. In yet further embodiments of the present invention the traffic rates are based on data collected using one or more of GPS units, radio RFID devices, motion detection cameras, thermal imaging devices, optical devices, mechanical devices, combinations thereof, or any other device or method for tracking in-store shopping patterns. In yet further embodiments of the present invention, the visit rate comprises an average number of store visits per household.

These and other objects and advantages of the present invention will become more apparent from the following detailed description considered with reference to the accompanying drawings.

### BRIEF DESCRIPTION OF THE DRAWINGS

FIG. 1 illustrates a system and method for in-store media measurement based on one embodiment of the present invention.

FIG. 2 illustrates one embodiment of a system for practicing the present invention.

FIG. 3 illustrates a query form according to one embodiment of the present invention.

FIG. 4 illustrates a response form according to one embodiment of the present invention.

FIG. 5 illustrates a method according to one embodiment of the present invention.

FIG. 6 illustrates a system and method for in-store media measurement based on one embodiment of the present invention.

FIG. 7 illustrates a response form according to one embodiment of the present invention.

### DETAILED DESCRIPTION OF THE INVENTION

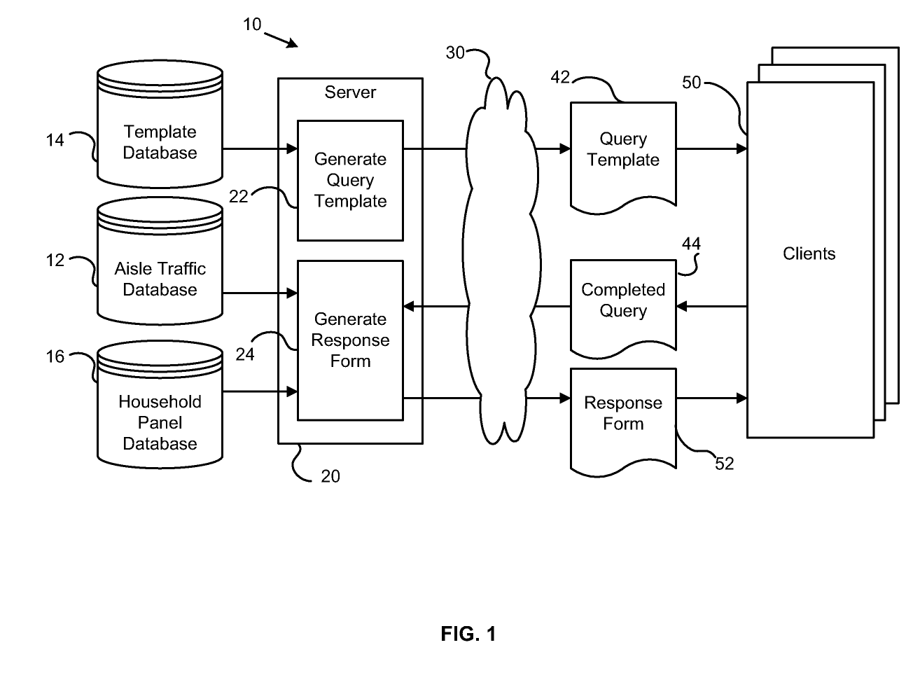

FIG. 1 illustrates a method and system 10 for determining the value of in-store media, for example an in-store marketing program, according to one embodiment of the present invention. The system 10 includes a server 20. The server 20 is in communication with a network 30. In some embodiments the server 20 may be a personal computer. In other embodiments the server 20 may be a plurality of servers in communication. For example, the server 20 may be part of a larger network. It should be understood to a person having ordinary skill in the art that the terms server and computer may be interchangeable.

The system 10 illustrated in FIG. 1 includes at least one template database 14 in communication with the server 20. The template data database 14 includes a plurality of query templates 42 for eliciting marketing program information regarding a particular advertising project, campaign, or marketing program. Marketing program information may include data related to a specific advertisement or promotional campaign, for example, the type of advertisement, the number of stores, the duration of advertisement, and target demographic. In other embodiments of the present invention marketing program information may include aisle location of the marketing program, the type of marketing program, i.e. target program, the cost of the marketing program, the number of cycles of the marketing program, and a target product usage.

In further reference to FIG. 1, the system 10 includes at least one aisle traffic database 12 in communication with the server 20. The aisle traffic database 12 includes data related to aisle traffic patterns of shoppers in stores. Aisle traffic data is collected through store aisle measurement, in which the location of shoppers are tracked and recorded using objective and statistically significant methods. In some embodiments of the present invention, aisle traffic data is collected and tracked, for example, using global positioning system (“GPS”) units, radio frequency identification devices (“RFID”), motion detection cameras, thermal imaging devices, optical devices, mechanical devices, combinations thereof, or any other device or method for tracking in-store shopping patterns. The store aisle traffic data is collected and analyzed to determine the likelihood that a person will walk to a certain location in the store during a shopping visit. For example, store aisle traffic data may indicate that the check out, entrance, and deli are visited most often, while the household products aisles are visited on only 30% of shopping trips. In yet further embodiments of the present invention, the store aisle traffic data can be used to determine the probability that an average shopper will visit any section of the store. In some embodiments of the present invention, the aisle traffic database includes a number of location identifiers, each said location identifier having an associated traffic rate. The location identifier is associated with a specific location in the store, such as the deli section, soda section, etc. The traffic rate associated with the location identifier reflects the probability that a person who enters the store will visit that location.

In further reference to FIG. 1, the system 10 includes at least one household panel database 16 in communication with the server 20. The household panel database 16 includes household panel data. Household panel data is customer data based on the actual shopping patterns of a sample population, as compared to survey data which is based on consumer recollection. The household panel data includes, for example, data related to the date and time of each shopping trip, the products purchased during each trip, and the name and address of the store. In addition, the household panel data includes data related to the demographics of the shopper's household. In other embodiments of the present invention, the system may alternatively include an individual panel database, wherein the data takes account of demographics and shopping patterns of an individual as opposed to a household. It should be understood that a combination of household data and individual data may be used with the present invention.

The household panel data may be collected using a number of different systems and methods. In general, the objective measurement of shopping patterns may be referred to as tracking receipts associated with purchases. This data may be collected by the shoppers at the point of purchase using a wand device or the like to record the products that are purchased. In yet other embodiments of the present invention, the data is collected using customer tracking programs that associate a particular customer with a number. At the point of check-out the unique customer number is entered and the system associates products purchased by that customer with that number. In reference to FIG. 1, in some embodiments of the present invention, the household panel database 16 includes a number of target program identifier, each said target program identifier having an associated visit rate. The target program identifier is associated with a specific type of marketing program. The visit rate is associated with a number of impressions of the target program during a given cycle.

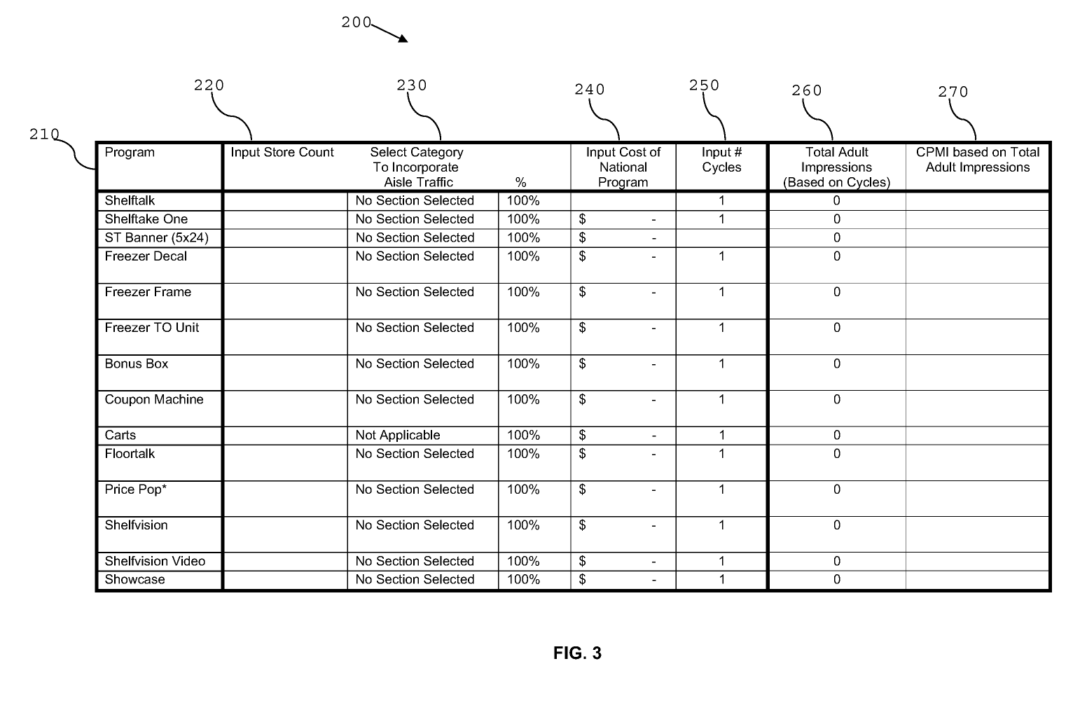

In reference to FIG. 3, a template 200 according to one embodiment of the present invention is illustrated. The template 200 includes data input fields for receiving data related to an in-store media or promotion. The template 200 includes a column 210 related to a type of advertising program, i.e. target program. For example the program may be a freezer decal or a cart advertisement. It should be understood to a person of ordinary skill in the art that in some embodiments of the present invention an identification of a target program is not required. In the embodiment shown in FIG. 3, trade names used by New America Inc. to identify certain in-store media programs are listed in column 210.

The template further includes a data column 220 related to the store count, i.e. the number of stores in which the advertising campaign is being placed. Column 220 includes a plurality of data input fields. A user can enter the number of stores in the input fields.

The template 200 further includes a column 230 to account for aisle traffic patterns. Column 230 includes a plurality of data input fields in which the user can input location of the in-store media program in the store. In some embodiments of the present invention the data input fields comprise drop down menus. In other embodiments of the present invention the user inputs text or numbers.

The template 200 further includes a cost column 240. The cost column 240 corresponds to the overall cost of a specific marketing program. The disclosed system and method derives the value of the in-store media program based on this overall cost. In some embodiments of the present invention, the overall cost corresponds to the total cost for the advertising program during a specific cycle. For example, one cycle may represent one month. In other embodiments of the present invention, the overall cost corresponds to the total cost for the marketing program during a set number of cycles. For example five cycles.

In further reference to FIG. 3, the template 200 includes a cycle column 250 related to the number of cycles of the marketing program. The cycle column 250 further includes a plurality of data entry fields for receiving data related to the number of cycles. In some embodiments the number of cycles relates to the duration of the advertising program. For example, one cycle may correspond to a period of one month in the system. If the user wants to derive a CPMI for a two month period, the user will enter two in the cycle column 250.

In further reference to FIG. 1, the server 20 is in communication with a network 30. For example, in some embodiments the server 20 is in communication with a local network. In other embodiments the server 20 is in communication with the Internet. In further reference to FIG. 1, the system 10 includes one or more clients 50 in communication with the network 30. The client 50 may include, but is not limited to, a desktop computer 152, a notebook computer 164, a tablet computer 154, a personal digital assistant 162, and a mobile phone 166. A client 50 in some embodiments is a device that primarily handles input (e.g., user interaction) and output (e.g., displaying), while processing is done on a separate server. In other embodiments processing of the client data is done on the client 50.

In further reference to the system 10 shown in FIG. 1, the system 10 comprises software executing on the server 20 for transmitting the query template 42 to a client 50 via the communication network 30. In some embodiments the software transmits the query template 42 to the client 50 via an email. In other embodiments the software transmits the query template 42 to the client 50 via text message (“SMS”), or an instant message (“IMS”). In some embodiments of the present invention the client retrieves the query template by accessing a remote web server. In some embodiments of the present invention the client 50 requests the query template 42. In other embodiments of the present invention the client 50 accesses the query template 42 via an interface in communication with the server 20.

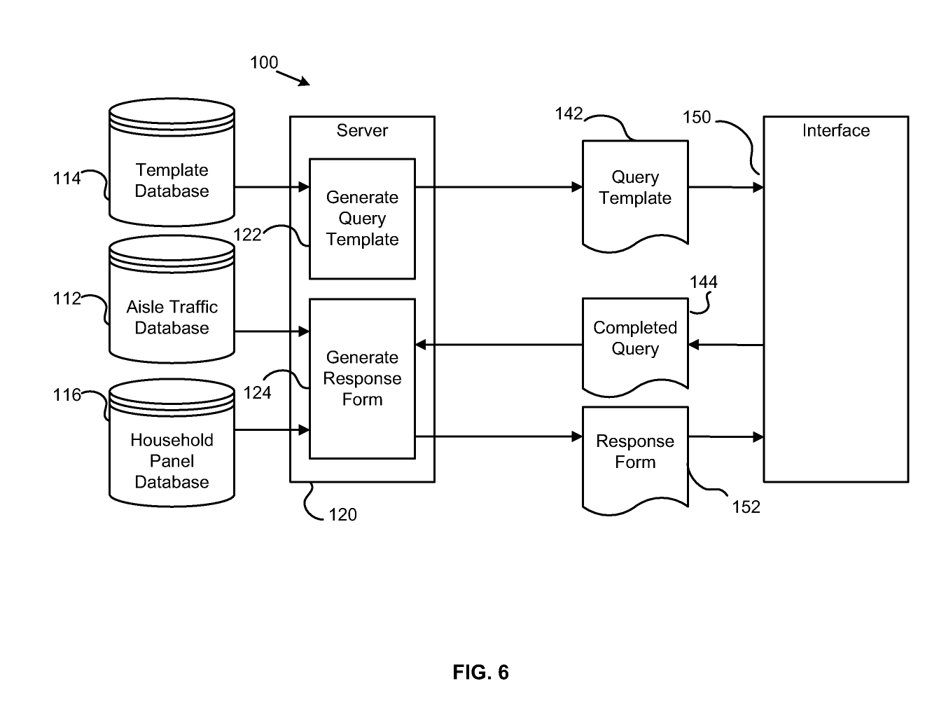

In reference to FIG. 6, a system and method 100 in accordance with one embodiment of the present invention is shown. The system 100 includes a server computer 120. The server computer 120 is in communication with a template database 114 containing at least one template, an aisle traffic database 112 containing at least one location identifier, and a household panel database 116 containing at least one target program identifier. The server computer 120 is connected to an interface 150. In some embodiments the interface 150 comprises a touch panel screen, in other embodiments, the interface comprises a keyboard, mouse, and monitor. It should be understood to a person having ordinary skill in the art that many different configurations are possible. The server computer 120 further includes software executing on the computer 120 for generating a query template 142. The server computer 120 further includes software for receiving a response, or completed query 142. The completed query 142 may include information related to a marketing program for which a value is sought, such as the location of the marketing program, the target program, the number of stores of the program, the number of cycles of the program, and the cost of the program. In addition, the completed query form 142 may include a specification for a demographic for which specific information is sought, and may further include a target product for which specific information is sought.

In some embodiments software executing in the server 20 pre-populates the template 42 with one or more fields of data corresponding to a particular advertising program. For example, the software executing on the server may pre-populate the template 42 with data related to a prior advertising program of the customer.

The query template 42 is displayed on an interface of the client 50. For example, the template 42 is displayed on a touchscreen tablet, or the screen of a personal computer. The user can enter additional data related to one or more advertising programs into one of more fields of the template 42 using the interface, for example, a keyboard, touch screen, or other input device on the client 50.

In further reference to FIG. 1, after the user inputs data into the system the client 50 transmits a completed query template 44 to the server 10. The client 50 transmits the completed query template 44 to the server 20 via the communication network 30. Software executing on the server 20 receives the completed query template 44 from the client 50. The client 50 may use any known means to transmit the completed template 44 to the network. For example, the client can transmit the completed template via email, SMS or IMS. In some embodiments the client 50 can access the server 20 through a remote web application and transmit the completed query template 44 to the server 20.

In reference to the embodiment shown in FIG. 1, the system 10 comprises software executing on the server 20 for receiving the completed query template 44. Software executing on the server 20 generates a response form 52 based on the completed query template 44. In some embodiments of the present invention, software executing on the server 20 stores the completed query template 44 in a database for later reference.

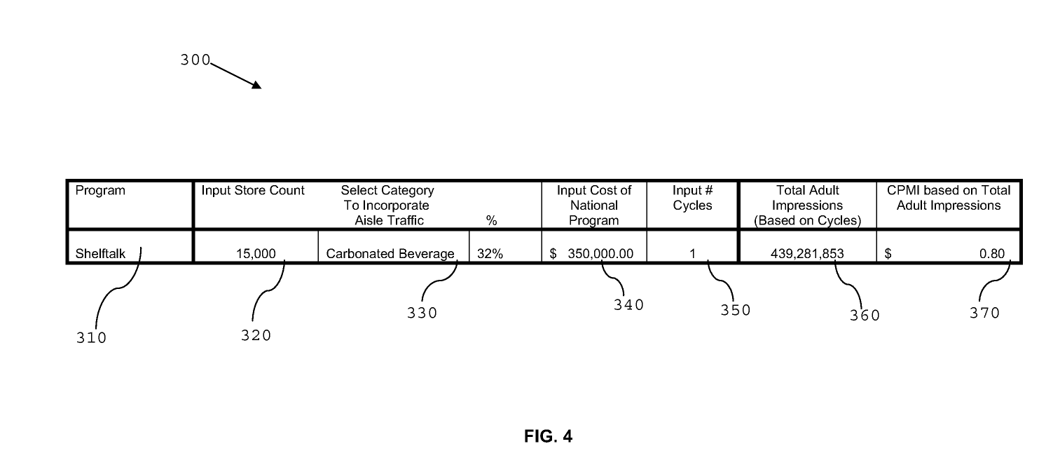

In reference to FIG. 4, a response template 300 according to one embodiment of the present invention is shown. The response form 300 includes a plurality of columns for data entry or display, wherein at least some of the columns correspond to one or more columns on the query template 42. In reference to the response template 300 shown in FIG. 4, columns 310, 320, 330, 340, and 350 include data originally provided by the customer. Based on this data the system of the present invention generates a total number of impressions for a specific in-store media or advertisement. In addition, the system calculates a CPMI based on the total number of impressions.

In further reference to in FIG. 4, a response form is shown in which the user entered data for an at-shelf program 310. The user inputted a store count of 15,000 at column 320, indicating that the Shelftalk program was placed in 15,000 stores. The user further inputted data indicating that this program would be placed in the carbonated beverage section of the store, column 330. Finally, the user input the total cost of the program $350,000 340 for one cycle, column 350.

Based on this user input, software executing on the server 20 generated a total number of impressions 360 for the program, and the CPMI or cost per thousand impressions 370. Software executing on the server 20 retrieves aisle traffic data based on the user input. More specifically, software executing on the server 12, 120 queries the aisle traffic database by the received location identifier to retrieve an aisle traffic rate. In this example, the user selected the carbonated beverage location identifier. Software executing on the system queries the aisle traffic database by the carbonated beverage traffic identifier to retrieve an aisle traffic rate associated with the carbonated beverage location. In the example shown in FIG. 4, the system retrieved traffic rate that indicates that 32% of shoppers who enter the store will walk through the carbonated beverage aisle.

The system further determines the number of impressions for a given cycle. The system further includes software executing on the server 12, 120 for querying the household panel database by the target program to retrieve a visit rate. The visit rate relates to the number of average visits per store during a given period. In some embodiments of the present invention, this impression per store(s) is based on the number of people who are likely to visit one of the participating stores during a given period and average frequency that person will visit the store. Software executing on the server 20, 120 retrieves data related to customer shopping trips during a given cycle from the household panel database. In alternative embodiments of the present invention, software executing on the server 20 retrieves data related to the customer shopping trips during a given cycle from an individual panel database.

The system generates the number of impressions for a given cycle by incorporating the household panel data and the aisle traffic data. Software executing on the server retrieves a number that relates to the average number of store visits per store during the cycle. For example, if cycle=1 corresponds to one month, the software will retrieve an average number of customer visits per store for that month. For example, the household panel data may indicate that approximately 91,000 people visit a specific type of store in an average month. In some embodiments of the present invention, the software accounts for additional demographic data. For example, the server may provide the number impressions for households having males between the age of 19 and 25 in a one month period. In yet other embodiments of the present invention, the system may indicate the number impressions for households having an annual income over $100,000 during a specific cycle.

Next, the software executing on the server 20 generates the total number of impressions for the demographic population. This number is based on the number of unique store visits and the location of the program in the store. Software executing on the server 20 generates total impressions by multiplying the number of store visits projected during the cycle by the percentage of visitors that visit the specific aisle or section of the store.

In reference to the example shown in FIG. 4, the program is placed in the carbonated beverage aisle. Software executing on the server retrieves a number from the aisle traffic database that corresponds with the percentage of store shoppers that walk through the carbonated beverage aisle, in this case 32%, during a store visit. The software executing on the system 10 determines the total number of impressions for the promotion program location in the carbonated beverage aisle by multiplying the number of store impressions for the month by 32%. In the example shown in FIG. 4, this number is displayed in the Total Adult Impressions column 360. This number indicates the total number of unique adult impressions of an in-store promotion during a one month cycle. As discussed above the demographic data can be selected to more narrowly focus the number of total impressions to a specific household or individual demographic. For example, number of female adult impressions for a one month period.

In further reference to FIG. 4, a CPMI based on the total number of impressions is calculated. As discussed above, the CPMI is a figure that represents the cost per thousand impressions. Software executing on the server 20 generates this number based on the cost of the national program and the number of impressions. In the embodiment of the present invention shown in FIG. 4, the software executing on the system generates the CPMI by dividing the Total Adult Impressions 360 with the Cost of the National Program 340, which results in a CPMI of $0.80. In other words a cost of $0.80 for every 1000 thousand impressions.

In reference to FIG. 4, software executing on the server 20 transmits the response form 52 to the client 50 via the network communication link 30. In some embodiments of the present invention, this information is displayed on an interface.

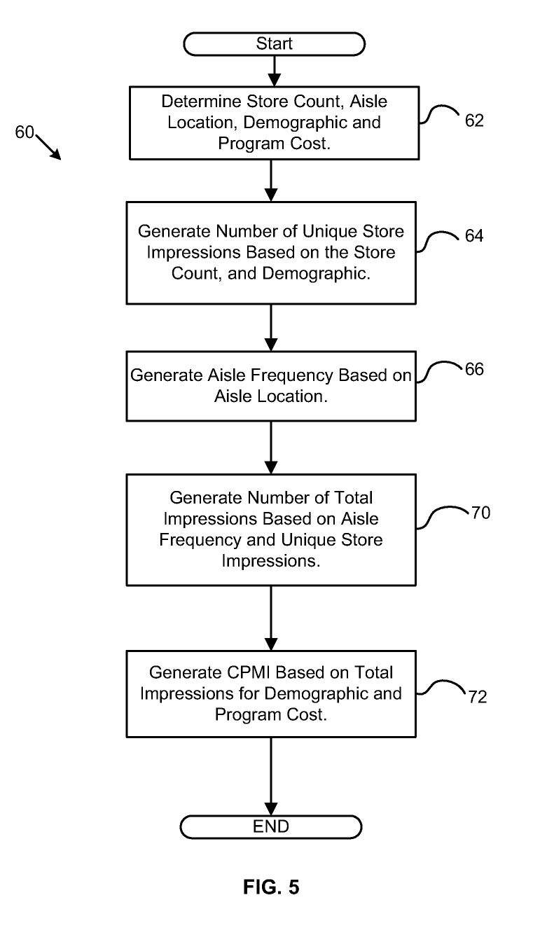

FIG. 5 illustrates a method 60 for generating a CPMI in accordance with one embodiment of the present invention. The method first determines the store count, the aisle location, demographic, and the program cost 62 for a given in-store advertising program. The store count is the number of stores the program is being placed in. The aisle location is the location of the in-store advertisement in the store. The demographic is a specific demographic for which a CPMI is sought, and program cost is the total cost of the program.

Next, the method generates the number of unique store impressions based on the store count and demographic 64. The number of unique store impressions corresponds to the number of unique store visits for the population identified in the demographic. This number is extrapolated from the household survey panel data.

Next, the method generates the aisle frequency based on the aisle location of the program 66. The aisle frequency is generated based on aisle tracking data generated by GPS, RFID, or similar tracking systems. Next the method generates the total impressions based on the aisle frequency and unique store impressions 70. Finally, the method generates a CPMI based on the total impressions for the given demographic and the program cost 72.

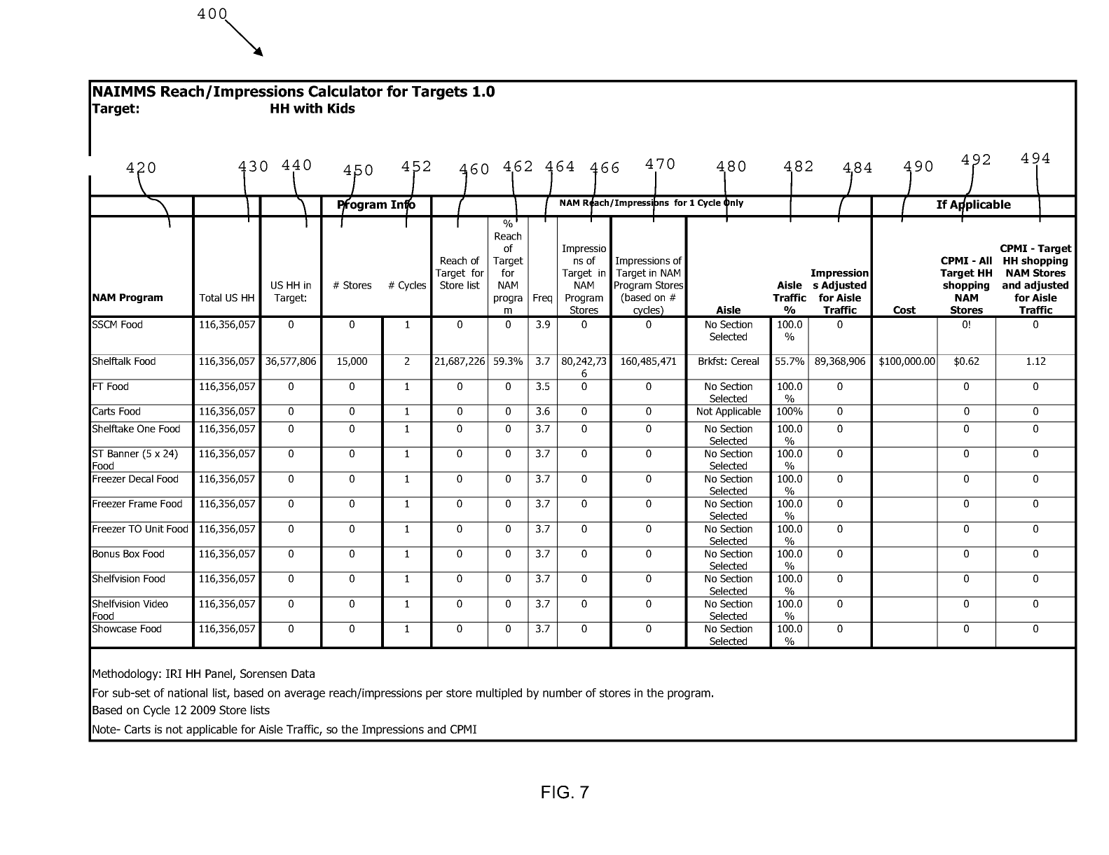

In reference to FIG. 7, a response form 400 according to one embodiment of the present invention is shown. The response form 400 includes a plurality of columns for data entry or display. In reference to the response form 400 shown in FIG. 7, the response form 400 in this embodiment is similar to the query template in that they both include the same number of columns.

In further reference to the response form 400, the user provides information in the number of stores column 450. This relates to the number of stores that the marketing program is being run in. The user selects a specific row to input the number of stores, and other relevant data, that corresponds to the target program of the marketing program. The target programs are shown in column 420. The user can also enter the number of cycles for which the program is set to run in the cycle column 452. In the example shown in FIG. 7, the user has selected two cycles. The user selects the location of the marketing program in the aisle column 480. In the example shown, the user has indicated that the marketing program is located in the breakfast/cereal aisle. In further reference to FIG. 7, a cost column 490 is providing for receiving a cost related to the marketing program. In the example shown, the user has input a cost of $100,000. Based on this information the system calculates a value of the specified in-store marketing program.

In further reference to FIG. 7, the response form illustrates the total number of households in the United States in the Total US HH column 430. This is the base number for which the total number of impressions is derived. In the next column, the total number of households in the target demographic is indicated in the US HH in Target column 440. This relates to a specific demographic for which an advertising value is determined. In this case, the demographic is U.S. households with children. The Reach of Target for Store List column 460 indicates the number of households that are likely to visit a store in which the specific marketing program is running. This is related to the number in the next column 462, which corresponds to a percentage of the total U.S. households in the specific demographic that are likely to visit the store in which the program is running. The likelihood of a visit can be determined by a number by considering a number different factors.

In further reference to FIG. 7, the Freq. column 464, relates to the average number of times a member of a household will visit a store during the given cycle. This number is based on objective household panel data. The frequency is multiplied by the reach to determine the overall impressions. In this case, the overall impressions is displayed in column 470. Next the overall impression is adjusted based on the specific location of the marketing program in the store. The percentage of store visitors who visit the breakfast/cereal location on a given trip is shown in the Aisle Traffic column 480. This percentage is multiplied by the total number of impressions to provide the impressions adjusted for aisle traffic shown in column 484. Finally, the CPMI is derived by dividing the cost by the total impressions adjusted for location and demographic, and then multiplying by 1000. The CPMI is shown in column 494 as $1.12. It should be understood by a person having ordinary skill in the art that many different configurations of response forms and query forms are possible.

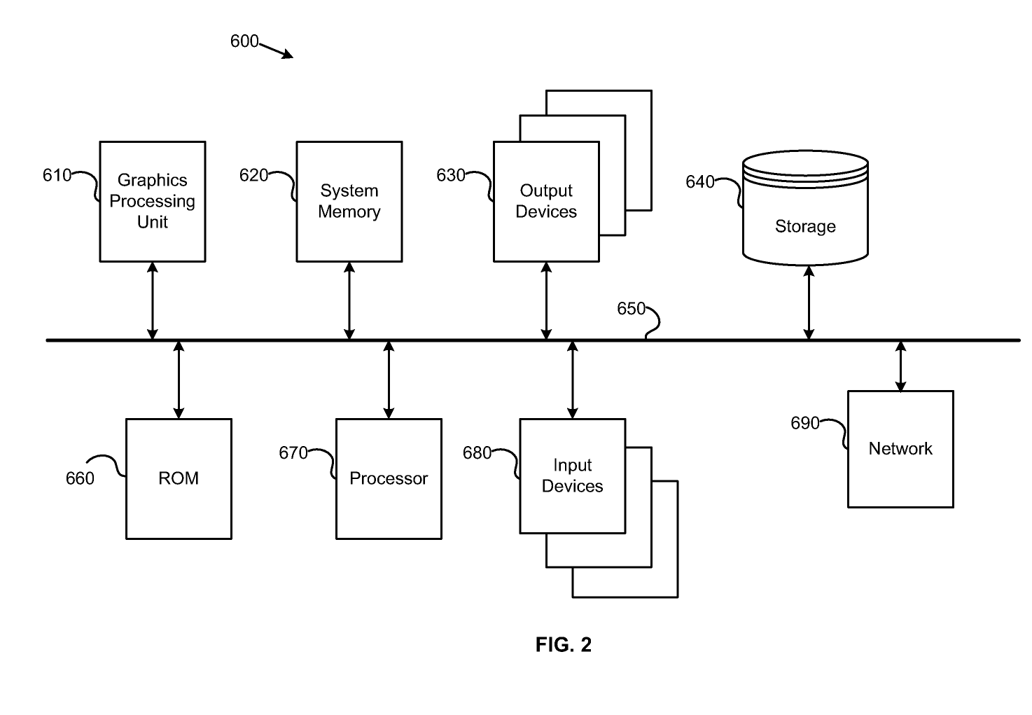

FIG. 2 conceptually illustrates a computer system with which some embodiments of the present invention are implemented. The computer system 600 includes a bus 650, a processor 670, a system memory 620, a read-only memory 660, a permanent storage device 640, input devices 680, and output devices 630. In some embodiments, the computer system also includes a graphic processing unit (GPU) 610.

The bus 650 collectively represents all system, peripheral, and chipset buses that support communication among internal devices of the computer system 600. For instance, the bus 650 communicatively connects the processor 670 with the read-only memory (ROM) 660, the system memory 620, and the permanent storage device 640.

From these various memory units, the processor 670 (also referred to as central processing unit or CPU) retrieves instructions to execute and data to process in order to execute the processes of the invention. The ROM 660 stores static data and instructions that are needed by the processor 670 and other modules of the computer system. The permanent storage device 640, on the other hand, is a read-and-write memory device. This device is a non-volatile memory unit that stores instruction and data even when the computer system 600 is off. Some embodiments of the invention use a mass-storage device (such as a magnetic or optical disk and its corresponding disk drive) as the permanent storage device 640. Other embodiments use a removable storage device (such as a floppy disk or Zip® disk, and its corresponding disk drive) as the permanent storage device 640.

Like the permanent storage device 640, the system memory 620 is a read-and-write memory device. However, unlike the storage device 640, the system memory is a volatile read-and-write memory, such as a random access memory. The system memory stores some of the instructions and data that the processor needs at runtime.

Instructions and/or data needed to perform processes of some embodiments are stored in the system memory 620, the permanent storage device 640, the read-only memory 660, or any combination of the three. For example, the various memory units may contain instructions for processing multimedia items in accordance with some embodiments. From these various memory units, the processor 670 retrieves instructions to execute and data to process in order to execute the processes of some embodiments.

The bus 650 also connects to the input and output devices 680 and 630. The input devices enable the user to communicate information and select commands to the computer system. The input devices 680 include alphanumeric keyboards, touch panels, and cursor-controllers. The input devices 680 also include scanners through which an image can be input to the computer system. The output devices 630 display images generated by the computer system. The output devices include printers, pen plotters, laser printers, ink-jet plotters, film recorders, and display devices, such as cathode ray tubes (CRT), liquid crystal displays (LCD), or electroluminescent displays.

Also, as shown in FIG. 2, bus 650 also couples the computer system 600 to a network 690 through a network adapter (not shown). In this manner, the computer can be a part of a network of computers (such as a local area network (“LAN”), a wide area network (“WAN”), or an Intranet) or a network of networks (such as the Internet). Finally, as shown in FIG. 2, the computer system in some embodiments also optionally includes a graphics processing unit (GPU) 610. A GPU (also referred to as a visual processing unit or a display processor) is a dedicated graphics rendering device which is very efficient in manipulating and displaying computer graphics. The GPU can be included in a video card (not shown) or can be integrated into the mother board of the computer system along with the processor 670. Also, the computer system 600 may be used as a personal computer, a workstation, a game console, or the like. Any or all of the components of the computer system 600 may be used in conjunction with the invention. However, one of ordinary skill in the art will appreciate that any other system configuration may also be used in conjunction with the invention.

Although the invention has been described with reference to a particular arrangement of parts, features and the like, these are not intended to exhaust all possible arrangements or features, and indeed many modifications and variations will be ascertainable to those of skill in the art.

What is claimed is:

1. A system for determining the media value of an in-store marketing program, comprising:
a computer;
an aisle traffic database containing a plurality of location identifiers, each said location identifier having an associated traffic rate;
a household panel database containing a plurality of target program identifiers, each said target program identifier having an associated visit rate;
software executing on said computer for querying said aisle traffic database by said location identifier to retrieve a traffic rate;
software executing on said computer for querying said household panel database by said target program identifier to retrieve a visit rate;
software executing on said computer for generating a media value for a marketing program based on said retrieved traffic rate and said retrieved visit rate;
wherein each said retrieved visit rate is generated using data collected from a panel of shoppers by tracking receipts of said shoppers.

2. The system of claim 1, wherein said media value is expressed as a cost per a number of impressions.

3. The system of claim 2, wherein said generation of said media value is further based on a number of stores in which said marketing program is placed.

4. The system of claim 3, wherein said generation of said media value is further based on a cost of said marketing program.

5. The system of claim 4, wherein said generation of said media value is further based on a number of cycles of said marketing program.

6. The system of claim 2, further comprising:
an interface;
software executing on said computer for receiving a location identifier and a target program identifier entered at said interface.

7. The system of claim 2, wherein said retrieved visit rate is adjusted based on a target demographic.

8. The system of claim 7, wherein the adjustment is based on the percentage of shoppers in the shopping panel who belong to the target demographic.

9. The system of claim 2, wherein said retrieved visit rate is adjusted based on a target product usage.

10. The system of claim 9, wherein the adjustment is based on the percentage of shoppers in the shopping panel who purchase the target product.

11. A method for determining the value of an in-store marketing program, comprising the steps of:
assigning an aisle traffic rate to a store location, wherein said aisle traffic rate is based on data collected from objectively collected data;
providing a number of impressions, wherein said number of impressions is generated using data collected from a panel of households by tracking receipts associated with purchases made by one or more members of each said household;
generating a media value based on said aisle traffic rate and said number of impressions.

12. The method of claim 11, further comprising the step of:
expressing the media value as a cost per a number of impressions.

13. The method of claim 12, wherein said generation of said media value is further based on a number of stores in which said marketing program is placed.

14. The method of claim 13, wherein said generation of said media value is further based on a cost of said marketing program.

15. The method of claim 14, wherein said generation of said media value is further based on a number of cycles of said marketing program.

16. The method of claim 11, further comprising the step of:
identifying a target demographic;
adjusting said number of impressions based on the percentage of shoppers in the shopping panel who belong to the target demographic.

17. The method of claim 16, further comprising the step of:
identifying a target product usage;
adjusting said number of impressions based on the percentage of shoppers in the shopping panel who purchase the target product.

18. A system for determining the value of an in-store marketing program, comprising:
a computer;
an aisle traffic database containing a plurality of locations identifiers, each said location identifier having an associated traffic rate;
a household panel database containing a plurality target program identifiers, each said target program identifier having an associated visit rate;
software executing on said computer for receiving a location identifier of a marketing program;
software executing on said computer for receiving a cost associated with said marketing program;
software executing on said computer for receiving a number of stores in which said marketing program is placed;
software executing on said computer for querying said aisle traffic database by said location identifier to retrieve a traffic rate;
software executing on said computer for querying said household panel database by said target program identifier to retrieve a visit rate;
software executing on said computer for generating a media value for a marketing program based on said retrieved traffic rate and said retrieved visit rate;
wherein said media value is further based on said received cost and said received number of stores;
wherein said retrieved visit rate is generated using data collected from a panel of households by tracking receipts associated with purchases made by one or more members of each said household.

19. The system of claim 18, wherein said retrieved visit rate comprises an average number of store visits per household.

20. The system of claim 19, wherein retrieved visit rate is adjusted based on a target demographic.

21. The system of claim 20, wherein the adjustment is based on the percentage of shoppers in the shopping panel who belong to the target demographic.

22. The system of claim 19, wherein said retrieved visit rate is adjusted based on a target product usage.

23. The system of claim 22, wherein the adjustment is based on the percentage of shoppers in the shopping panel who purchase the target product.

24. A system for determining the value of an in-store marketing program, comprising:
a computer;
an aisle traffic database containing a plurality of locations identifiers, each said location identifier having an associated traffic rate;
software executing on said computer for querying said aisle traffic database by said location identifier to retrieve a traffic rate;
software executing on said computer for generating a media value for a marketing program based on said retrieved traffic rate and a visit rate, said visit rate being associated a number of store visits;
wherein said visit rate is generated using data collected from a panel of households by tracking receipts associated with purchases made by one or more members each said household;
wherein each said traffic rate is based on data collected using at least one of an RFID tag and a GPS unit.

25. The system of claim 24, wherein said media value is expressed as a cost per a number of impressions.

26. The system of claim 25, wherein said visit rate is adjusted based on a target demographic.

27. The system of claim 26, wherein the adjustment is based on the percentage of shoppers in the shopping panel who belong to the target demographic.

28. The system of claim 25, wherein said visit rate is adjusted based on a target product usage.

29. The system of claim 28, wherein the adjustment is based on the percentage of shoppers in the shopping panel who purchase the target product.
